(19) United States
(12) Patent Application Publication
(10) Pub. No.: US 2020/0241366 A1
(43) Pub. Date: Jul. 30, 2020

(54) LIQUID CRYSTAL DISPLAY PANEL AND DISPLAY DEVICE

(71) Applicant: Wuhan China Star Optoelectronics Technology Co., Ltd., Wuhan (CN)

(72) Inventor: Xiuping SONG, Wuhan (CN)

(73) Assignee: Wuhan China Star Optoelectronics Technology Co., Ltd., Wuhan (CN)

(21) Appl. No.: 16/492,130

(22) PCT Filed: Jul. 2, 2019
(86) PCT No.: PCT/CN2019/094356

§ 371 Date: Sep. 8, 2019

(30) Foreign Application Priority Data
Dec. 29, 2018 (CN) 201811633188.8

(51) Int. Cl. G02F 1/1343; G02F 1/1362

(52) U.S. Cl. CPC G02F 1/134309; G02F 2201/123; G02F 2201/121; G02F 1/136286

(57) ABSTRACT

A liquid crystal display panel and a display device, the liquid crystal display panel comprises: a first substrate, a second substrate disposed opposite to the first substrate, and a liquid crystal layer disposed between the first substrate and the second substrate; wherein a first electrode layer is disposed on one surface of the first substrate toward the liquid crystal layer, a second electrode layer is disposed on one surface of the second substrate toward the liquid crystal layer, and the first electrode layer and the second electrode layer are disposed axisymmetrically by the liquid crystal layer as axis.

### FIELD OF INVENTION

The present disclosure relates to the field of display technologies, and more particularly to a liquid crystal display panel and a display device.

### BACKGROUND OF INVENTION

With screens of smart phones become large, reducing the power consumption of mobile phones is an important factor for mobile phone manufacturers to consideration. For liquid crystal display (LCD), reducing backlight power consumption has a significant effect. However, reducing backlight power consumption will inevitably reduce backlight brightness, and therefore reduce screen brightness if transmittance of liquid crystal display panel maintains unchanged.

The present disclosure provides a solution for the technical problem of how to reduce backlight power consumption and increase transmittance of liquid crystal display panel at the meantime, thereby increasing screen brightness.

### SUMMARY OF INVENTION

In the first aspect, an embodiment of the present disclosure provides a liquid crystal display panel. The liquid crystal display panel comprises:

a first substrate, a second substrate disposed opposite to the first substrate, and a liquid crystal layer disposed between the first substrate and the second substrate.

A first electrode layer is disposed on one surface of the first substrate toward the liquid crystal layer. A second electrode layer is disposed on one surface of the second substrate toward the liquid crystal layer, the first electrode layer and the second electrode layer are disposed axisymmetrically by the liquid crystal layer as axis.

The first electrode layer comprises a first common electrode layer, a first insulation layer and a first pixel electrode layer stacked in sequence, and the second electrode layer comprises a second common electrode layer, a second insulation layer and a second pixel electrode layer stacked in sequence.

The first pixel electrode layer comprises a plurality of first pixel electrodes, the second pixel electrode layer comprises a plurality of second pixel electrodes, and each of the first pixel electrodes is corresponding to each of the second pixel electrodes.

The liquid crystal layer comprises a plurality of liquid crystal molecules, and the liquid crystal molecules have a predetermined pretilt angle with respect to the first substrate and the second substrate by a rubbing alignment process.

In an embodiment of the present disclosure, an orthographic projection of the first pixel electrodes on the first substrate coincides with an orthographic projection of the second pixel electrodes on the first substrate.

In an embodiment of the present disclosure, a voltage applied to the first common electrode layer is the same as a voltage applied to the second common electrode layer, and a voltage applied to the first pixel electrode layer is the same as a voltage applied to the second pixel electrode layer.

In an embodiment of the present disclosure, an orthographic projection of the first common electrode layer on the first substrate coincides with an orthographic projection of the first insulation layer on the first substrate, and an orthographic projection of the second common electrode layer on the second substrate coincides with an orthographic projection of the second insulation layer on the second substrate.

In an embodiment of the present disclosure, the first common electrode layer comprises a plurality of first common electrodes, and the second common electrode layer comprises a plurality of second common electrodes.

Each of the first common electrodes is corresponding to each of the second common electrodes.

In an embodiment of the present disclosure, an orthographic projection of each of the first common electrodes on the first substrate coincides with an orthographic projection of each of the second common electrodes on the first substrate.

In an embodiment of the present disclosure, each of the first pixel electrodes is correspondingly disposed between the adjacent first common electrodes, and each of the second pixel electrodes is correspondingly disposed between the adjacent second common electrodes.

In an embodiment of the present disclosure, a plurality of the first common electrodes are arranged at intervals, and a plurality of the second common electrodes are arranged at intervals; wherein each of the first pixel electrodes is correspondingly disposed at the intervals of the first common electrodes, and each of the second pixel electrodes is correspondingly disposed at the intervals of the second common electrodes.

In the second aspect, an embodiment of the present disclosure further provides a liquid crystal display panel. The liquid crystal display panel comprises: a first substrate, a second substrate disposed opposite to the first substrate, and a liquid crystal layer disposed between the first substrate and the second substrate.

A first electrode layer is disposed on one surface of the first substrate toward the liquid crystal layer, a second electrode layer is disposed on one surface of the second substrate toward the liquid crystal layer, the first electrode layer and the second electrode layer are disposed axisymmetrically by the liquid crystal layer as axis.

In an embodiment of the present disclosure, the first electrode layer comprises a first common electrode layer, a first insulation layer and a first pixel electrode layer stacked in sequence, and the second electrode layer comprises a second common electrode layer, a second insulation layer and a second pixel electrode layer stacked in sequence.

The first pixel electrode layer comprises a plurality of first pixel electrodes, the second pixel electrode layer comprises a plurality of second pixel electrodes, and each of the first pixel electrodes is corresponding to each of the second pixel electrodes.

In an embodiment of the present disclosure, an orthographic projection of the first pixel electrodes on the first substrate coincides with an orthographic projection of the second pixel electrodes on the first substrate.

In an embodiment of the present disclosure, a voltage applied to the first common electrode layer is the same as a voltage applied to the second common electrode layer, and a voltage applied to the first pixel electrode layer is the same as a voltage applied to the second pixel electrode layer.

In an embodiment of the present disclosure, an orthographic projection of the first common electrode layer on the first substrate coincides with an orthographic projection of the first insulation layer on the first substrate, and an orthographic projection of the second common electrode layer on the second substrate coincides with an orthographic projection of the second insulation layer on the second substrate.

In an embodiment of the present disclosure, the first common electrode layer comprises a plurality of first common electrodes, and the second common electrode layer comprises a plurality of second common electrodes.

Each of the first common electrodes is corresponding to each of the second common electrodes.

In an embodiment of the present disclosure, an orthographic projection of each of the first common electrodes on the first substrate coincides with an orthographic projection of each of the second common electrodes on the first substrate.

In an embodiment of the present disclosure, each of the first pixel electrodes is correspondingly disposed between the adjacent first common electrodes, and each of the second pixel electrodes is correspondingly disposed between the adjacent second common electrodes.

In an embodiment of the present disclosure, a plurality of the first common electrodes are arranged at intervals, and a plurality of the second common electrodes are arranged at intervals; wherein each of the first pixel electrodes is correspondingly disposed at the intervals of the first common electrodes, and each of the second pixel electrodes is correspondingly disposed at the intervals of the second common electrodes.

In the third aspect, an embodiment of the present disclosure further provides a display device. The display device comprises a liquid crystal display panel.

The liquid crystal display panel comprises a first substrate, a second substrate disposed opposite to the first substrate, and a liquid crystal layer disposed between the first substrate and the second substrate.

A first electrode layer is disposed on one surface of the first substrate toward the liquid crystal layer, a second electrode layer is disposed on one surface of the second substrate toward the liquid crystal layer, the first electrode layer and the second electrode layer are disposed axisymmetrically by the liquid crystal layer as axis.

The beneficial effect of the present disclosure is: it can counteract the electric field force in the vertical direction of the liquid crystal layer by disposing a first electrode layer on the first substrate and disposing a second electrode layer on the second substrate. Therefore, it can reduce backlight power consumption and increase transmittance of the liquid crystal display panel at the meantime, thereby increasing screen brightness.

### DESCRIPTION OF DRAWINGS

The accompanying figures to be used in the description of embodiments of the present disclosure or prior art will be described in brief to more clearly illustrate the technical solutions of the embodiments or the prior art. The accompanying figures described below are only part of the embodiments of the present disclosure, from which figures those skilled in the art can derive further figures without making any inventive efforts.

FIG. 1 is a schematic structural diagram of the first embodiment of the provided liquid crystal display panel in the present disclosure.

FIG. 2 is a schematic diagram of liquid crystal molecules deflection of the provided liquid crystal display panel in the present disclosure.

FIG. 3 is a schematic structural diagram of current liquid crystal display panel.

FIG. 4 is a schematic structural diagram of the second embodiment of the provided liquid crystal display panel in the present disclosure.

### DETAILED DESCRIPTION OF PREFERRED EMBODIMENTS

The embodiments of the present disclosure are described in detail hereinafter. Examples of the described embodiments are given in the accompanying drawings, wherein the identical or similar reference numerals constantly denote the identical or similar elements or elements having the identical or similar functions. The specific embodiments described with reference to the attached drawings are all exemplary and are intended to illustrate and interpret the present disclosure, which shall not be construed as causing limitations to the present disclosure.

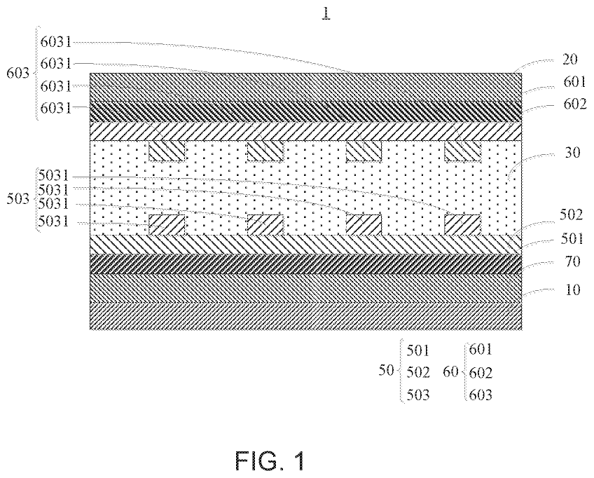

Referring to FIG. 1, FIG. 1 is a schematic structural diagram of the first embodiment of the provided liquid crystal display panel in the present disclosure.

An embodiment of the present disclosure provides a liquid crystal display panel 1, comprising a first substrate 10 and a second substrate 20 disposed opposite to the first substrate 10, and a liquid crystal layer 30 disposed between the first substrate 10 and the second substrate 20. Wherein a first electrode layer 50 is disposed on one surface of the first substrate 10 toward the liquid crystal layer 30, a second electrode layer 60 is disposed on one surface of the second substrate 20 toward the liquid crystal layer 30, the first electrode layer 50 and the second electrode layer 60 are disposed axisymmetrically by the liquid crystal layer 30 as axis.

The liquid crystal layer 30 comprises a plurality of liquid crystal molecules 301, the liquid crystal molecules 301 are liquid crystal materials having a deflection orientation characteristic in a specific direction by applying a driving voltage, and achieving different deflection orientations by the thresholds of applied driving voltages. A reactive monomer is a polymeric monomer, comprising one or more of acrylate resin monomer, methacrylate resin monomer, vinyl resin monomer, vinyloxy resin monomer, and epoxy resin monomer. The reactive monomer is used to form a polymer on the surface of the substrate by an ultraviolet light process when applying a driving voltage to adjust the orientation of liquid crystal molecules 301, thereby obtaining the liquid crystal layer 30 which specifies a pointing direction and a pretilt angle even without an applied voltage. Of course, it's not limited by this. The liquid crystal molecules 301 can also have a predetermined pretilt angle with respect to the first substrate 10 and the second substrate 20 by an ordinary rubbing alignment process.

By disposing a first electrode layer 50 on the first substrate 10, and disposing a second electrode layer 60 on the second substrate 20, the first electrode layer 50 provides the liquid crystal layer 30 an electric field force in a first direction which can counteract an electric field force in a second direction provided by the second electrode layer 60 to the liquid crystal layer 30 when the liquid crystal display panel 1 is working, thereby making the liquid crystal molecules 301 in the liquid crystal layer 30 deflect along the horizontal direction. Therefore, it can reduce backlight power consumption and increase the transmittance of the liquid crystal display panel 1 at the meantime, thereby increasing screen brightness.

It should be noted that, in the embodiment of the present disclosure, the first direction is perpendicular to the first substrate 10, and the second direction is perpendicular to the second substrate 20, and the first direction is vertically upward and the second direction is vertically downward.

Referring to FIG. 1, the first electrode layer 50 comprises a first common electrode layer 501, a first insulation layer 502 and a first pixel electrode layer 503 stacked in sequence. The second electrode layer 60 comprises a second common electrode layer 601, a second insulation layer 602 and a second pixel electrode layer 603 stacked in sequence. Wherein the first pixel electrode layer 503 comprises a plurality of first pixel electrodes 5031, the second pixel electrode layer 603 comprises a plurality of second pixel electrodes 6031, and each of the first pixel electrodes 5031 is corresponding to each of the second pixel electrodes 6031.

The first common electrode layer 501 is disposed on one surface toward the liquid crystal layer 30. The first insulation layer 502 and the first pixel electrode layer 503 are disposed on the first common electrode layer 501 in sequence in the direction from the first substrate 10 to the liquid crystal layer 30. The second common electrode layer 601 is disposed on one surface toward the liquid crystal layer 30. The first insulation layer 602 and the first pixel electrode layer 603 are disposed on the first common electrode layer 601 in sequence in the direction from the second substrate 20 to the liquid crystal layer 30.

The first substrate 10 can be an array substrate. The second substrate 20 can be a color film substrate. It can form a thin-film transistor layer 70 on the first substrate 10. The thin-film transistor layer 70 and the first electrode layer 50 are electrical connected to apply a common-mode voltage signal to the first common electrode layer 501 and a pixel voltage signal to the first pixel electrode layer 503.

A plurality of first pixel electrodes 5031 are arranged at intervals, a plurality of second pixel electrodes 6031 are arranged at intervals, and each of the first pixel electrodes 5031 is corresponding to each of the second pixel electrodes 6031, to make the electric field force in the first direction provided by the first pixel electrodes 5031 to the liquid crystal layer 30 counteract the electric field force in the second direction provided by the second pixel electrodes 6031 to the liquid crystal layer 30.

In some embodiments of the present disclosure, an orthographic projection of the first pixel electrodes 5031 on the first substrate 10 coincides with an orthographic projection of the second pixel electrodes 6031 on the first substrate 10.

Besides, it should be noted that, the second electrode layer 60 disposed on the second substrate 20 is to counteract the electric field force in the vertical direction on the first electrode layer 50. Therefore, it is not necessary to provide a thin-film transistor on the second substrate 20 to drive the second electrode layer 60. It is only necessary to supply a voltage to the second electrode layer 60 by some metal wires, such as signal lines.

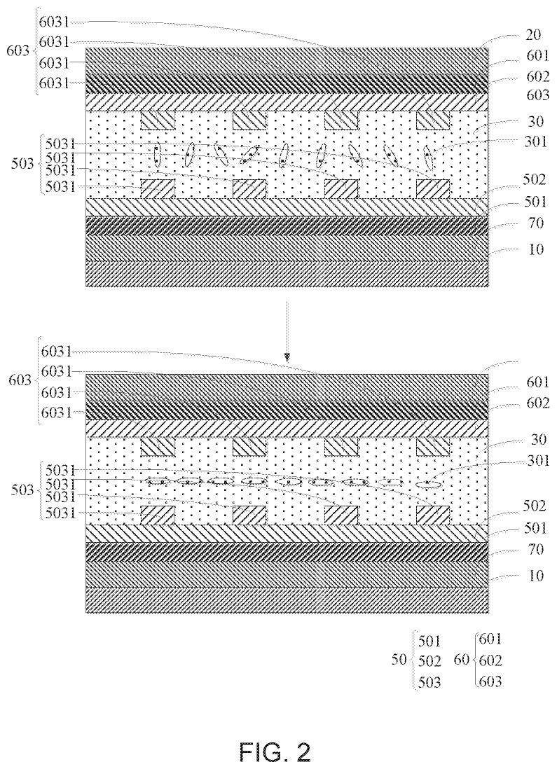

Referring to FIG. 2, FIG. 2 is a schematic diagram of liquid crystal molecules deflection of the provided liquid crystal display panel in the present disclosure. When the liquid crystal display panel 1 is not working, the liquid crystal molecules 301 in the liquid crystal layer 30 are disorganized distributed in the liquid crystal layer 30. Due to providing a first electrode layer 50 on the first substrate 10 and providing a second substrate 20 on the second electrode layer 60, when the liquid crystal display panel 1 is working, in order to make the electric field force in the first direction provided by the first electrode layer 50 to the liquid crystal layer 30 counteract the electric field force in the second direction provided by the second electrode layer 60 to the liquid crystal layer 30, the voltage of the first common electrode layer 501 can be set the same as the voltage of the second common electrode layer 601, and the voltage of the first pixel electrode layer 503 can be set the same as the voltage of the second pixel electrode layer 603.

It is, in some embodiments of the present disclosure, the voltage applied to the first common electrode layer 501 is the same as the voltage applied to the second common electrode layer 601, and the voltage applied to the first pixel electrode layer 503 is the same as the voltage applied to the second pixel electrode layer 603.

Besides, in the horizontal direction, the electric field force received by the liquid crystal molecules 301 is the sum of electric field force in the horizontal component provided by the first electrode layer 50 and electric field force in the horizontal component provided by the second electrode layer 60. That is, the liquid crystal display panel 1 of the present disclosure can reduce power consumption.

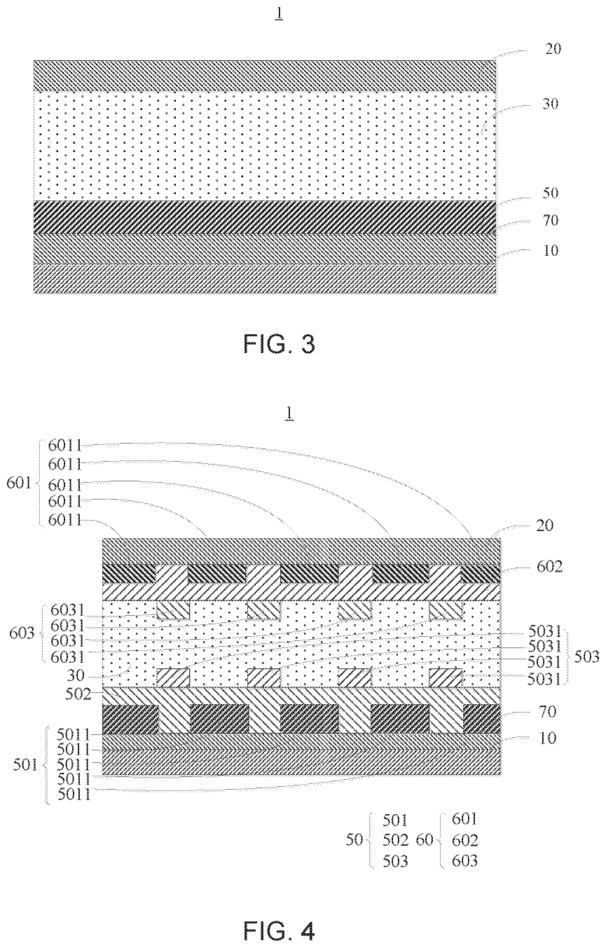

Referring to FIG. 1, FIG. 2 and FIG. 3, FIG. 3 is a schematic structural diagram of current liquid crystal display panel.

For example, apply a voltage of 10V to a first electrode layer 50 in the current liquid crystal display panel 1 to make liquid crystal molecules 301 of liquid crystal layer 30 in the current liquid crystal display panel 1 deflect, and in the liquid crystal display panel 1 in the present disclosure, it is only necessary to individually apply a voltage of 5V to the first electrode layer 50 and the second electrode layer 60 to make the liquid crystal molecules 301 of the liquid crystal layer 30 in the liquid crystal display panel 1 deflect. Therefore, the liquid crystal display panel 1 in the present disclosure reduces power consumption.

Referring to FIG. 4, FIG. 4 is a schematic structural diagram of the second embodiment of the provided liquid crystal display panel in the present disclosure. The present disclosure further provides a liquid crystal display panel 1. The difference of the liquid crystal display panel 1 in FIG. 4 and the liquid crystal display panel 1 in FIG. 1 is: the first common electrode layer 501 comprises a plurality of first common electrodes 5011, and the second common electrode layer 601 comprises a plurality of second common electrodes 6011. Each of the first common electrodes 5011 is corresponding to each of the second common electrodes 6011.

In order to make the electric field force in the vertical direction of the liquid crystal molecules 301 in the liquid crystal layer 30 become zero, the size of each first common electrode 5011 can be the same as the corresponding second common electrode 6011. It is, in some embodiments of the present disclosure, an orthographic projection of each of the first common electrode 5011 on the first substrate 10 coincides with an orthographic projection of each of the second common electrode 6011 on the first substrate 10.

Besides, in order to make each liquid crystal molecule 301 of the liquid crystal layer 30 received the same electric field force, the first pixel electrodes 503 can be correspondingly disposed between the adjacent first common electrodes 501, and the second pixel electrodes 603 can be correspondingly disposed between the adjacent second common electrodes 601.

It is, in some embodiments of the present disclosure, each first pixel electrode 503 is correspondingly disposed between the adjacent first common electrodes 501, and each second pixel electrode 603 is correspondingly disposed between the adjacent second common electrodes 601. It should be noted that, the meaning of the first pixel electrode 503 being correspondingly disposed between the adjacent first common electrodes 501 is referring to: the orthographic projection of each first pixel electrode 503 on the first substrate 10 is between the orthographic projections of the adjacent first common electrodes 501 on the first substrate 10. The meaning of the second pixel electrode 603 being correspondingly disposed between the adjacent second common electrodes 601 is referring to: the orthographic projection of each second pixel electrode 603 on the second substrate 20 is between the orthographic projections of the adjacent second common electrodes 601 on the second substrate 20.

In order to further achieve the object of the electric field forces received by each liquid crystal molecule 301 in the liquid crystal layer 30 being the same, a plurality of the first common electrodes 501 are disposed on the first substrate 10 at intervals, and a plurality of the second common electrodes 601 are disposed on the second substrate 20 at intervals. Please refer to FIG. 4, a plurality of the first common electrodes 501 are arranged at intervals, and a plurality of the second common electrodes 601 are arranged at intervals. Each first pixel electrode 503 is correspondingly disposed at the intervals of the first common electrodes 501, each second pixel electrode 603 is correspondingly disposed at the intervals of the second common electrodes 601.

A plurality of first common electrodes 501 are disposed on the first substrate 10, and a plurality of second common electrodes 601 are disposed on the second substrate 20, when the liquid crystal display panel 1 is working, the electric field force in the vertical direction of the first common electrodes 501 will counteract the electric field force in the vertical direction of the second common electrodes 601, and the electric field force in the vertical direction of the first pixel electrodes 503 will counteract the electric field force in the vertical direction of the second pixel electrodes 603, thereby achieving the object of the electric field forces received by each liquid crystal molecule 301 in the liquid crystal layer 30 can be the same. Therefore, it can reduce backlight power consumption and increase transmittance of the liquid crystal display panel 1 at the meantime, thereby increasing screen brightness.

An embodiment of the present disclosure further provides a display device, and the display device comprises a liquid crystal display panel 1. Please refer to above embodiments for the specific structure of the liquid crystal display panel 1, which will not be iterated herein for the sake of conciseness.

An embodiment of the present disclosure provides a liquid crystal display panel and a display device. The liquid crystal display panel comprises: a first substrate, a second substrate disposed opposite to the first substrate, and a liquid crystal layer disposed between the first substrate and the second substrate;

wherein a first electrode layer is disposed on one surface of the first substrate toward the liquid crystal layer, a second electrode layer is disposed on one surface of the second substrate toward the liquid crystal layer, and the first electrode layer and the second electrode layer are disposed axisymmetrically by the liquid crystal layer as axis. The present disclosure provides a first electrode layer disposed on the first substrate and a second electrode layer disposed on the second substrate to counteract the electric field force in the vertical direction of liquid crystal layer. Therefore, it can reduce backlight power consumption and increase transmittance of the liquid crystal display panel at the meantime, thereby increasing screen brightness.

The liquid crystal display panel and the display device provided in the embodiments of the present disclosure are described above in detail, and principles and embodiments of the disclosure are described in specific examples for understanding. For those skilled in the art, there will be changes in the scope of specific implementations and applications according to the idea of the present disclosure. In summary, the description of the present disclosure shall not be construed as causing limitations to the present disclosure.

What is claimed is:

1. A liquid crystal display panel, comprising:
a first substrate, a second substrate disposed opposite to the first substrate, and a liquid crystal layer disposed between the first substrate and the second substrate;
wherein a first electrode layer is disposed on one surface of the first substrate toward the liquid crystal layer, a second electrode layer is disposed on one surface of the second substrate toward the liquid crystal layer, and the first electrode layer and the second electrode layer are disposed axisymmetrically by the liquid crystal layer as axis;
the first electrode layer comprises a first common electrode layer, a first insulation layer and a first pixel electrode layer stacked in sequence, and the second electrode layer comprises a second common electrode layer, a second insulation layer and a second pixel electrode layer stacked in sequence;
the first pixel electrode layer comprises a plurality of first pixel electrodes, the second pixel electrode layer comprises a plurality of second pixel electrodes, and each of first pixel electrodes is corresponding to each of second pixel electrodes;
the liquid crystal layer comprises a plurality of liquid crystal molecules, and the liquid crystal molecules have a predetermined pretilt angle with respect to the first substrate and the second substrate by a rubbing alignment process.

2. The liquid crystal display panel according to claim 1, wherein an orthographic projection of the first pixel electrodes on the first substrate coincides with an orthographic projection of the second pixel electrodes on the first substrate.

3. The liquid crystal display panel according to claim 2, wherein a voltage applied to the first common electrode layer is the same as a voltage applied to the second common electrode layer, and a voltage applied to the first pixel electrode layer is the same as a voltage applied to the second pixel electrode layer.

4. The liquid crystal display panel according to claim 1, wherein an orthographic projection of the first common electrode layer on the first substrate coincides with an orthographic projection of the first insulation layer on the first substrate, and an orthographic projection of the second common electrode layer on the second substrate coincides with an orthographic projection of the second insulation layer on the second substrate.

5. The liquid crystal display panel according to claim 1, wherein the first common electrode layer comprises a plurality of first common electrodes, and the second common electrode layer comprises a plurality of second common electrodes; wherein each of the first common electrodes is corresponding to each of the second common electrodes.

6. The liquid crystal display panel according to claim 5, wherein an orthographic projection of each of the first common electrodes on the first substrate coincides with an orthographic projection of each of the second common electrodes on the first substrate.

7. The liquid crystal display panel according to claim 6, wherein each of the first pixel electrodes is correspondingly disposed between the adjacent first common electrodes, and each of the second pixel electrodes is correspondingly disposed between the adjacent second common electrodes.

8. The liquid crystal display panel according to claim 7, wherein a plurality of the first common electrodes are arranged at intervals, and a plurality of the second common electrodes are arranged at intervals; wherein each of the first pixel electrodes is correspondingly disposed at the intervals of the first common electrodes, and each of the second pixel electrodes is correspondingly disposed at the intervals of the second common electrodes.

9. A liquid crystal display panel, comprising: a first substrate, a second substrate disposed opposite to the first substrate, and a liquid crystal layer disposed between the first substrate and the second substrate;
wherein a first electrode layer is disposed on one surface of the first substrate toward the liquid crystal layer, a second electrode layer is disposed on one surface of the second substrate toward the liquid crystal layer, and the first electrode layer and the second electrode layer are disposed axisymmetrically by the liquid crystal layer as axis.

10. The liquid crystal display panel according to claim 9, wherein the first electrode layer comprises a first common electrode layer, a first insulation layer and a first pixel electrode layer stacked in sequence, and the second electrode layer comprises a second common electrode layer, a second insulation layer and a second pixel electrode layer stacked in sequence;
the first pixel electrode layer comprises a plurality of first pixel electrodes, the second pixel electrode layer comprises a plurality of second pixel electrodes, and each of the first pixel electrodes is corresponding to each of the second pixel electrodes.

11. The liquid crystal display panel according to claim 10, wherein an orthographic projection of the first pixel electrodes on the first substrate coincides with an orthographic projection of the second pixel electrodes on the first substrate.

12. The liquid crystal display panel according to claim 11, wherein a voltage applied to the first common electrode layer is the same as a voltage applied to the second common electrode layer, and a voltage applied to the first pixel electrode layer is the same as a voltage applied to the second pixel electrode layer.

13. The liquid crystal display panel according to claim 10, wherein an orthographic projection of the first common electrode layer on the first substrate coincides with an orthographic projection of the first insulation layer on the first substrate, and an orthographic projection of the second common electrode layer on the second substrate coincides with an orthographic projection of the second insulation layer on the second substrate.

14. The liquid crystal display panel according to claim 10, wherein the first common electrode layer comprises a plurality of first common electrodes, and the second common electrode layer comprises a plurality of second common electrodes; wherein each of the first common electrodes is corresponding to each of the second common electrodes.

15. The liquid crystal display panel according to claim 14, wherein an orthographic projection of each of the first common electrodes on the first substrate coincides with an orthographic projection of each of the second common electrodes on the first substrate.

16. The liquid crystal display panel according to claim 15, wherein each of the first pixel electrodes is correspondingly disposed between the adjacent first common electrodes, and each of the second pixel electrodes is correspondingly disposed between the adjacent second common electrodes.

17. The liquid crystal display panel according to claim 16, wherein a plurality of the first common electrodes are arranged at intervals, and a plurality of the second common electrodes are arranged at intervals; wherein each of the first pixel electrodes is correspondingly disposed at the intervals of the first common electrodes, and each of the second pixel electrodes is correspondingly disposed at the intervals of the second common electrodes.

18. A display device, comprising a liquid crystal display panel; the liquid crystal display panel comprising a first substrate, a second substrate disposed opposite to the first substrate, and a liquid crystal layer disposed between the first substrate and the second substrate;
wherein a first electrode layer is disposed on one surface of the first substrate toward the liquid crystal layer, a second electrode layer is disposed on one surface of the second substrate toward the liquid crystal layer, and the first electrode layer and the second electrode layer are disposed axisymmetrically by the liquid crystal layer as axis.

19. The display device according to claim 18, wherein the first electrode layer comprises a first common electrode layer, a first insulation layer and a first pixel electrode layer stacked in sequence, and the second electrode layer comprises a second common electrode layer, a second insulation layer and a second pixel electrode layer stacked in sequence;
the first pixel electrode layer comprises a plurality of first pixel electrodes, the second pixel electrode layer comprises a plurality of second pixel electrodes, and each of the first pixel electrodes is corresponding to each of the second pixel electrodes.

20. The display device according to claim 19, wherein an orthographic projection of the first pixel electrodes on the first substrate coincides with an orthographic projection of the second pixel electrodes on the first substrate.
